(19) United States
(12) Patent Application Publication
(10) Pub. No.: US 2023/0019862 A1
(43) Pub. Date: Jan. 19, 2023

(54) SYSTEMS AND METHODS PROVIDING MEDICAL PRIVILEGING AND DATA OVER DATA NETWORKS USING A DISTRIBUTED LEDGER

(71) Applicant: JENNIFER HARRELL VINES, Dallas, TX (US)

(72) Inventor: JENNIFER HARRELL VINES, Dallas, TX (US)

(21) Appl. No.: 17/686,210

(22) Filed: Mar. 3, 2022

Related U.S. Application Data
(63) Continuation-in-part of application No. 15/725,833, filed on Oct. 5, 2017, now abandoned.
(60) Provisional application No. 62/404,560, filed on Oct. 5, 2016.

(51) Int. Cl. G06F 21/62; G06F 21/60; G06F 21/31

(52) U.S. Cl. CPC G06F 21/6245; G06F 21/602; G06F 21/31

(57) ABSTRACT

Systems and methods provide credentialing and privilege processing, management, control and exchanges of data for authorized users. A server accessible from clients over a data network can provide centralized credentialing forms, receive supplemental information in association with medical provider application, and authenticate and grant access to records and forms associated with the medical provider to hospitals and third party institutions authorized by the medical provider to access and provide records in support of the medical provider's application for privileges, and thereby access, to medical providing institutions. Artificial intelligence and distributed ledger interaction with the server enhances application processing and controlled access to data.

### INVENTION PRIORITY

The present application is a Continuation-In-Part of U.S. patent application Ser. No. 15/725,833, filed Oct. 5, 2017, entitled “SYSTEMS AND METHODS PROVIDING MEDICAL PRIVILEGING AND DATA OVER DATA”, which is a continuation of U.S. Provisional Patent Application No. 62/404,560, filed Oct. 5, 2016, also entitled “SYSTEMS AND METHODS PROVIDING MEDICAL PRIVILEGING AND DATA OVER DATA”, which are both herein incorporated by reference in their entirety.

### FIELD OF THE EMBODIMENTS

The embodiments are generally related to credentialing and verifying professionals and the skilled for positions in industry, and in particular medical service provider credentialing and healthcare organization credentialing. More particularly the embodiments are related to systems and methods centralizing and streamlining healthcare privileging for medical service providers that can decrease time required to apply for privileges and reduce administrative costs for healthcare organizations.

### BACKGROUND

The U.S. Department of Health and Human Services' definition of credentialing is “the process of assessing and confirming the qualifications of a licensed or certified health care practitioner.” Credentialing is an essential process that healthcare organizations and practices must perform to ensure those providing medical services are qualified to do so.

The process has become more complicated over time due to the expansion of providers' scopes of service, the requirements of third-party payers (e.g., the U.S. government and private health insurance plans), and organizational standards (accrediting bodies).

The companion piece to credentialing is “privileging”, which is the process of authorizing a licensed or certified medical service provider's specific scope of patient care services. Privileging is performed in conjunction with an evaluation of an individual's clinical qualifications and/or performance.

In the past, credentialing and privileging were mainly associated with hospitals. Now, these processes are being required at healthcare facilities, ambulatory surgical centers, and long-term care organizations (collectively “healthcare organizations”). Credentialing and verifying also applies broadly to other industries as well as credit granting processes at financial institutions.

Healthcare organizations are responsible for validating the competency of their medical staff through credentialing and privileging. These processes are closely tied to reimbursement, accreditation standards, and state and federal laws. Although credentials and privileges will vary among medical service providers (depending on their backgrounds, qualifications, areas of practice, and practice settings), having detailed and consistent credentialing and privileging processes is imperative.

The healthcare organizations privileging process has been dysfunctional and extremely time consuming. Many hospitals continue to use paper applications while constantly receiving incomplete submission files that delay their ability to hire a provider. Currently, medical service providers who are applying for privileging at a hospital must print multiple applications and forms to be completed and returned. In addition, all medical school and licensing verification is also completed via paper forms. All the paper documents are either saved in physical file folders or scanned and saved to management software. The process is scattered, not uniform and time consuming.

The client health system has recognized that the way its credentialing activities are currently being carried out across its system does not consistently achieve the level of quality, timeliness, efficiency, high reliability, uniformity and value needed to succeed in today's environment. Specific challenges include: inconsistency and lack of standardization with credentialing and privileging processes; lengthy turnaround times for the initial appointment process; and lack of medical service provider satisfaction with the credentialing and privileging process.

Centralized credentialing can resolve some of the complexities of credentialing and privileging, however the unique nuances of each healthcare organization's bylaws and how they impact the delineation of privileges seems to be a barrier to such a product/service existing up to now (as the bylaws would need to be standardized across participating healthcare organizations). What is needed are systems and methods to streamline the healthcare organizations privileging process, decreases the time required to apply for privileges, control access and access levels to information, and reduces administrative costs for healthcare organizations.

### SUMMARY OF THE EMBODIMENTS

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract.

It is a feature of the present embodiments to provide access to a platform wherein users such as medical service providers (e.g., medical doctors) are not just filling in an application for credentialing, but where they can also manage and secure their data. It is another feature of the present embodiments to enable users with more interaction with a credentialing system and with data recipients such as healthcare organizations (e.g., hospitals) through a credentialing system.

It is a feature of the present embodiments to overcome the current problems associated with professional credentialing and privilege management (i.e., healthcare institution access). It is a feature of the embodiments to provide a network accessible application for the healthcare organizations privileging process that can leverage any combination of artificial intelligence, computer assets, cloud-based assets, and distributed ledgers to enable medical service provider data storage and security as well as control over providing access to select data by healthcare organizations and select third parties.

In accordance with features of the embodiments, with a centralized system users can remotely access systems containing credentialing and managing privileges for medical service providers using their electronic clients (e.g., desktops computers, tablets, smartphones).

In accordance with an example embodiment, a network accessible server can be provided that is configured to register users, collect data, process data, authorize access to the exchange or provision of data to requesting users and essentially streamline the privilege management process.

For healthcare organizations like hospitals, features of the embodiments can enable healthcare organizations to:
Eliminate paper applications and forms
Retrieve and download application files of medical service providers
Efficiently utilize centralized credentialing and privileging systems for initial and renewal privileging
First source verifies references
Gain easy access licensing documentation.

For medical service providers such as medical doctors, features of the embodiments can enable them to:
Enter application information once, which can be saved for future use
Eliminate the need for repetitive record retrieval from former employers, licensing agencies, medical schools
Enable worldwide access to data
Enable single contact and verification of references, with reference information being saved in a medical provider profile
Provide an economically feasible profile management and access from cloud-based or distributed ledger platforms under the appearance of a centralized platform.

It is another feature that, during registration, a medical service provider can initially set up a user account and profile including completing a single application that is a compilation of numerous application fields from a variety of healthcare organizations. The application can be saved to the medical service provider's profile in any of a remote server (e.g., the service cloud) or a distributed ledger. In addition, the medical service providers can request references from others either by searching and locating someone who is currently using the service, or by sending an email that allows them access to the service. The references can complete a single reference form online and that can be saved to the medical service provider's profile. The medical service provider can also have the ability to upload medical school documentation, licensing verification or certification verification. These documents can be securely saved to the medical service provider's profile. When the profile is complete, medical service providers can search for healthcare organizations to select for receiving their privileging application. The healthcare organizations' privileging fee can be charged via the credentialing platform to the medical service provider, along with a nominal fee per application. Furthermore, medical service providers can have the opportunity to maintain their privileges profile for a monthly maintenance fee. This information can remain accessible to them while allowing for additional information to be uploaded. Future privileging applications can be submitted via the service.

In accordance with features of the present embodiments, healthcare organizations can more efficiently process new and renewal privileging applications via the system. Healthcare organizations can have user credentials with which to access a dashboard. This dashboard can provide a page on which to choose fields from the general application that meet their needs. Healthcare organizations can be alerted to privileging applications for their institution and can view the medical service provider's profile, application, and documents. The healthcare organization can then have the ability to categorize each applicant based on the action taken. Healthcare organizations can choose whether to maintain their applicant information in the service cloud or distributed ledger, or to download it to their own information management systems.

In accordance with features of the present embodiments, references can be requested via the medical service provider, but an additional level of security can be provided to ensure first source verification. References can utilize a link to access their dashboard, and once a profile is created, a verification code can be emailed. This code can be required to log-in and continue to the reference form. The referral form can be completed once and electronically signed, then uploaded to the medical service provider's profile.

In accordance with additional features of the embodiments, time saving features enable healthcare providers to complete and attest to multiple state credentialing applications in one intelligent workflow design, upload supporting documents directly into a database to eliminate the need for manual submission and to improve the timeliness of completed applications, review and approve information before data is imported, protect against delays in data processing with more focused prompts and real-time validation, and enable self-registration with the system before a health plan initiates the application process.

In accordance with additional features of the embodiments, a system can be provided for credentialing and privilege processing, management, control, and data exchange for authorized users that includes a server accessible from clients over a data network, the server providing centralized credentialing forms to service providers and adapted for receiving supplemental information in association with service provider applications associated with a service provider, an artificial intelligence (AI) module configuring the server to process input and data provided from at least one of a service provider and third party sources on behalf of the service provider, wherein the AI module can populate credentialing forms and an access level to one or more data portion of records and forms associated with the service provider by reviewing parties, and access to a blockchain network. The blockchain network can be adapted to authenticate and grant access to the records and forms associated with the service provider to organizations authorized by the service provider to access and provide records in support of the service provider application for privileges, and thereby access the records after a log-in to the server by the organizations.

In accordance with additional features of the embodiments, one or more non-transitory computer readable media can be provided having program instructions stored thereon which, when executed by at least one processor, cause a machine to: receive a request to view one or more access-controlled data portions of a blockchain entry representing service provider data in support of credentialing; identify the one or more data portions, and an access level set by a data provider, associated with the request; and generate a customized view of any of the one or more data portions according to the access level. When executed by the at least one processor, the program instructions can further cause the machine to apply at least one redaction to any of the one or more data portions not associated with the access level. When executed by the at least one processor to receive the request, the program instructions further cause the machine to receive data representative of an access code associated with the request. The data representative of the access code includes at least one of: a pin code, a password, a fingerprint, a barcode, a retinal scan, a token, a questionnaire, and a multi-factor security authenticator. When executed by the at least one processor, the program instructions further cause the machine to validate access to view the one or more data portions based on the access level, and wherein when executed by the at least one processor to generate the customized view, the program instructions further cause the machine to generate the customized view in response to the access being validated. When executed by the at least one processor, the program instructions further cause the machine to evaluate the access level to determine the any of the one or more data portions accessible by the request, and wherein when executed by the at least one processor to generate the customized view, the program instructions further cause the machine to generate the customized view in response to the access level being evaluated.

In accordance with additional features of the embodiments, a method can be provided for providing credentialing and privilege processing, management, control, and exchanges of data for authorized users. As part of the method, a server accessible from clients over a data network can be provided, the server providing centralized credentialing forms to service providers and adapted for receiving supplemental information in association with service provider applications associated with a service provider. An artificial intelligence (AI) module can be provided that configures the server to process input and data provided from at least one of a service provider and third-party sources on behalf of the service provider, wherein the AI module can populate credentialing forms and an access level to one or more data portion of records and forms associated with the service provider by reviewing parties. Access to a blockchain network can be provided, wherein the blockchain network can be configured to: authenticate and grant access to the records and forms associated with the service provider to an organization authorized by the service provider to access and provide records in support of the service provider application for privileges, and thereby access after a log-in to the server, to the organization. The blockchain network can be further configured by the server to: receive a signal encoding data representative of a request to view the one or more data portions of a blockchain entry that are access-controlled; identify the one or more data portions, and an access level, associated with the request; validate access to view the one or more data portions based on the access level; generate a customized view of any of the one or more data portions according to the access level; and cause the customized view to be displayed via a user device in response to the validating the access.

In accordance with additional features of the embodiments, authenticating and granting access to records and forms associated with the service provider can include registering the service provider with a centralized credentialing and privilege/management administration system associated with the server, in response to a user input. Registering of the service provider can further include electronically setting up a personal profile; electronically filling out at least one medical provider application among the service provider applications; uploading credential documents; and identifying references. The credential documents can include at least one of: a college degree or a license. The references can include peer references. The server can further provide monitoring of a status of at least one service provider application among the service provider applications when the service provider has logged into the server and after the registering is complete. Authenticating and granting of access to the records and forms associated with the service provider can include registering the service provider with a centralized credentialing and privilege/management administration system associated with the server, in response to a user input. Registering of the service provider can include electronically setting up a personal profile, electronically filling out at least one service provider application among the service provider applications; uploading credential documents and identifying references. Credential documents can include at least one of: a college degree or a license. References can include peer references. Third parties can include hospitals and third party institutions include credentialing agents. The server can operate to allow the credentialing agents to send and/or receive text messages from the organizations and third party institutions.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention;

FIG. 1 illustrates a block diagram of a system that can be used to implement embodiments of the present invention;

FIG. 2 illustrates a flow diagram for a process in accordance with the embodiments a flow diagram of example modules for a process that can be carried out by a medical service provider (e.g., “Provider”), in accordance with features of the embodiments;

FIG. 3 illustrates a flow diagram for an application that a healthcare organization (e.g., “Hospital”) can follow to access the credentialing and privileging service system and medical service provider information provider, in accordance with features of the embodiments;

FIG. 4 illustrates a flow diagram for a process wherein third parties (e.g., “Credentialing Agent/Staffing Org”) can access the credentialing and privileging management system and medical service provider information, in accordance with features of the embodiments;

FIG. 5 illustrates a block diagram for a credentialing system that can maintain two distributed ledger profile databases: medical service Providers and healthcare Organizations, in accordance with features of the embodiments;

FIG. 6 illustrates a flow diagram for registration wherein users can be separated into EddyOne Providers and EddyCore Organizations, in accordance with features of the embodiments;

FIG. 7 illustrates a flow diagram of how AI within a platform of a credentialing system can adapt common form fields according to the medical service provider classification, location, certifications, etc., reducing the time required to complete profiles, in accordance with features of the embodiments;

FIG. 8 illustrates a diagram of how healthcare organization profiles and medical service provider databases can be stored in separate distributed ledger environments, and each mirrored in the backup blockchain, in accordance with features of the embodiments;

FIG. 9 illustrates a diagram of details for how aspects of the EddyCore—Client organization platform that can be integrated in the credentialing system, in accordance with features of the embodiments;

FIG. 10 illustrates a diagram of an EddyCore—Payor Enrollment Tracking aspect of a credentialing system, in accordance with features of the embodiments;

FIG. 11 illustrates a diagram for the privileges aspects of a credentialing system, in accordance with features of the embodiments;

FIG. 12 illustrates a diagram for licensing aspects of a credentialing system, in accordance with features of the embodiments;

FIG. 13 illustrates a diagram of an ongoing monitoring aspects of a credentialing system, in accordance with features of the embodiments.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is therefore not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms, such as “and”, “or”, or “and/or,” as used herein may include a variety of meanings that may depend, at least in part, upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

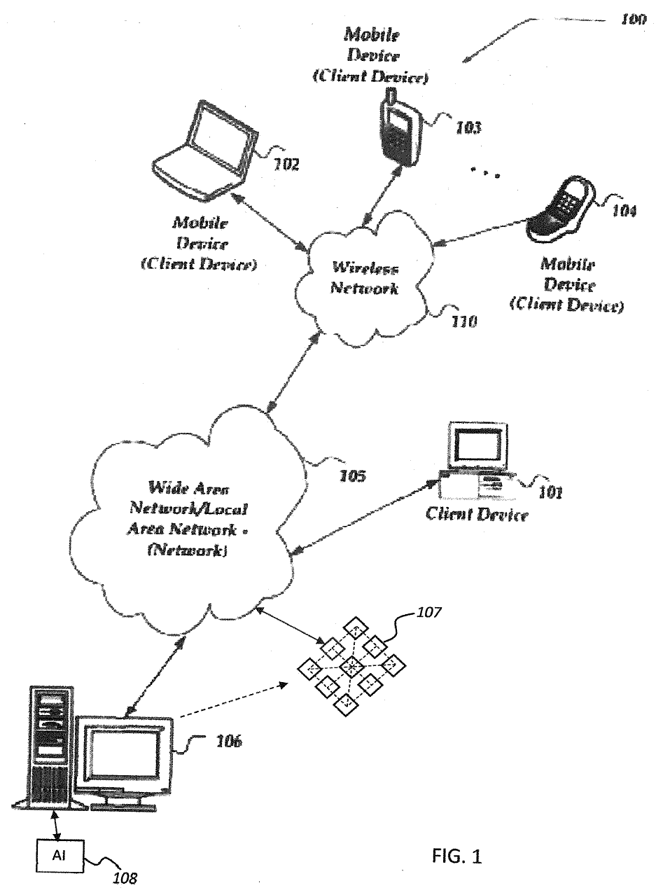

FIG. 1 illustrates a schematic diagram depicting an example embodiment of a system 100 composed of one or more networks. System 100 is an example of an environment in which a system for mapping notable entities to their social profiles, as described in greater detail herein, may operate. Other embodiments that may vary, for example, in terms of arrangement or in terms of type of components, are also intended to be included within the claimed subject matter. The system 100 depicted in FIG. 1, for example, can include a variety of networks, such as a WAN (Wide Are Network)/LAN (Local Area Network) 105, a wireless network 110, and a variety of devices, such as a client device 101 and mobile devices 102, 103, 104, and a variety of servers, such as credentialing and privileges server (SAS) 106. Server 106 can also be representative cloud-based services and can also operate in cooperation with a distributed ledger 107 (i.e., blockchain). An artificial intelligence (AI) module 108 can be accessed by the credentialing and privileges server 106 to analyze information provided users and assist with population of forms as well as assignment of security preferences for data. In the example configuration depicted in FIG. 1, mobile devices 102, 103, and 104 are client devices that communicate wirelessly with system 100 through the wireless network 110. The WAN/LAN network 105 also communicates with the wireless network 110.

A server, such as credentialing/privilege server 106, may include a device that includes a configuration to receive, process and provide service provider (e.g., medical doctor/medical service provider) information and related data via a network from/to device such as mobile devices 102 through 104, and client device 101. A SAS server 106 may, for example, host a website, and can enable secure log-in functionality for users to engage with and provide/receive data from the server 106. Data can be assigned to distributed ledger 107 for storage/access, and access can be provided based on authentication and permissions set up by the server 106.

A network, such as network 105 and/or network 110 depicted in FIG. 1, can couple devices so that communications and data may be exchanged, such as between a server 106 and a client device 101 or other types of devices, including between wireless devices 103/104 coupled via a wired or wireless network 110, for example. A network may also include mass storage, such as network-attached storage (NAS), a storage area network (SAN), cloud-based, distributed ledger, or other forms of computer or machine-readable media, for example. A network may include the Internet, one or more Local Area Networks (LANs), one or more Wide Area Networks (WANs), wire-line type connections, wireless type connections, or any combination thereof. Likewise, sub-networks may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices can be remotely coupled to a network, such as via a telephone line or link, for example.

A wireless network such as the wireless network 110 depicted in FIG. 1 may couple client devices with the network. That is, such a wireless network may employ stand-alone ad-hoc networks, mesh networks, wireless LAN (WLAN) networks, cellular networks, or the like. A wireless network such as wireless network 110 can further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, 4G, 5G, and so on) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks (e.g., networks 105, 110) may be compatible with or compliant with one or more protocols. The signaling formats or protocols employed may include, for example, TCP/IP, UDP, DECnet, NetBEUI, IPX, AppleTalk, or the like. Versions of the Internet Protocol (IP) may include IPv4 or IPv6.

The Internet refers to a decentralized global network of networks. The Internet can include Local Area Networks (LANs), Wide Area Networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc., that may route the signal packet in accordance with a target address and availability of a network path to the target address.

A web site in accordance with embodiment of the present invention can function in or with credentialing/privilege server 106 and allow for three separate user-types to log in: healthcare organizations (both current and prospective), medical service providers (e.g., Medical Doctors) and third parties associated with organizations/providers (e.g., insurance carriers, etc.).

For healthcare organizations (e.g., hospitals), features of the embodiments can enable them to:
Eliminate paper applications and forms
Retrieve and download application files of medical professionals
Efficiently utilize centralized credentialing and privileging systems for initial and renewal privileging
First source verifies references
Gain easy access licensing documentation.

For medical service providers, features of the embodiments can enable them to:
Enter application information once, which can be saved for future use
Eliminate the need for repetitive record retrieval from former employers, licensing agencies, medical schools.
Enable worldwide access to data
Enable single contact and verification of references, with reference information being saved in a medical provider profile.
Provide an economically feasible profile management and access from one centralized platform.

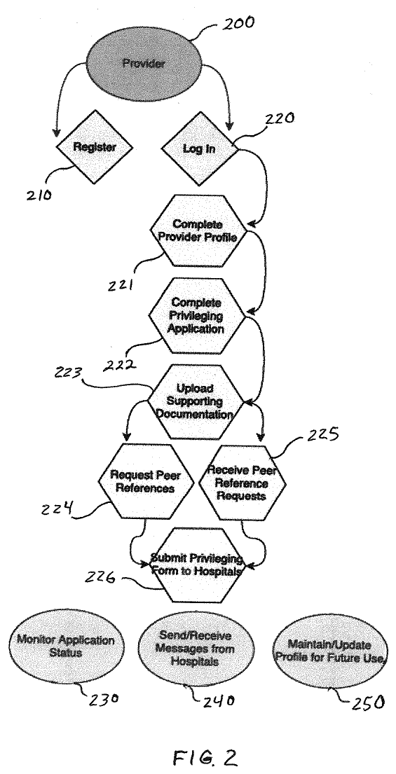

Referring to FIG. 2, a flow diagram for a process in accordance with the embodiments a flow diagram of example modules for a process that can be carried out by a medical service provider, in accordance with features of the embodiments. A centralized credentialing and privilege management/administration system can support the delivery of electronic documents to authorized (e.g., registered) users, and eliminate the need for paper application in the credentialing and privileging process. A medical service provider 200 (“Provider”) can register with a centralized credentialing and privilege management system as show the rectangular block 210 entitled “Register.” Registration can include setting up a personal profile, filing out an application, uploading credential documents (e.g., degrees, licenses), and identifying references. After being registered, the Provider can log In to the system as shown in the block 220 labeled “Log in”. When logged into the system, a Provider can: complete provider profile 221, complete privileging application 222, upload supporting documentation 223, request peer references 224, receive peer references requests 225, and submit privileging form to healthcare organizations 226 (“Hospitals”). Once the Provider has a completed credentialing package stored in a database within a remote server (e.g., in the cloud), the Provider can monitor application status 230, send/receive messages from Hospitals 240, maintain/update a profile for future use 250.

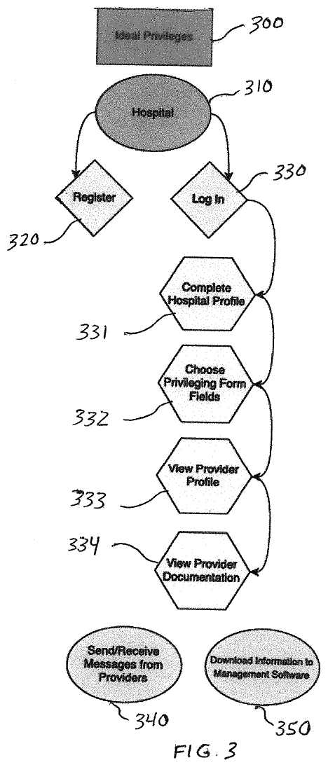

Referring to the flow diagram in FIG. 3, an application 300 referred to as “Ideal Privileges” can provide a healthcare organization 310 (e.g., “Hospital”) access to the credentialing and privileging service system. A Hospital (like any healthcare organization) can register 320 with the system. Once registered, the Hospital can log in to the system as shown in block 330. Once logged in, the hospital can complete Hospital profiles 331, choose privileging form fields 332, view provider profiles 333, and view Provider documentation 334. Once registered and obtaining access to data Hospitals can send/receive messages from providers 340 and Download Information to management software 350.

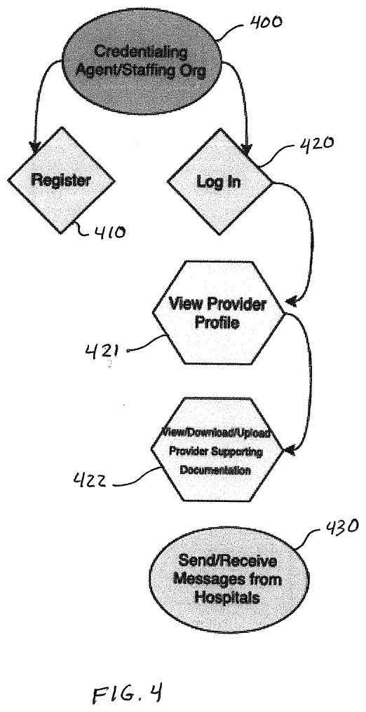

Referring to the flow diagram in FIG. 4, third parties 400 (e.g., “Credentialing Agent/Staffing Org”) can access the credentialing and privileging management system. Like the medical service providers and healthcare organizations, the credentialing agents can register 410 with the system and Log In 420 to the system to obtain access to data. The third parties can also be authorized to securely view provider profiles 421, view and download/upload Provider supporting documentation 422. The third parties can also send/receive messages from hospitals and medical service providers 430.

Distributed ledgers 107 (Blockchains) allow a network of users to make a digital ledger of data and share the data among the other users in the network. Unlike previous database structures, the blockchain database is maintained by a multitude of independent nodes spread across a large, distributed network. When a transaction is recorded into the blockchain database, it is very difficult, if not impossible, to change or remove that data from the database since the data is stored in more than one node in the distributed network. Therefore, data can be added into the blockchain database by multiple users and changing the recorded data would require each of these users (or a majority of the users) to agree to the change. This distribution of control to add, edit, and remove data from the blockchain database creates trust amongst users in the network, especially when users are not familiar with one another.

Artificial intelligence (AI) is a concept that enable the creation of intelligent machines and that can simulate human thinking capability and behavior, whereas machine learning is an application or subset of AI that allows machines to learn from data without being programmed explicitly. AI as used herein includes machine learning in processing privilege and credentialing application by providers within the credentialing and privileging management system 106.

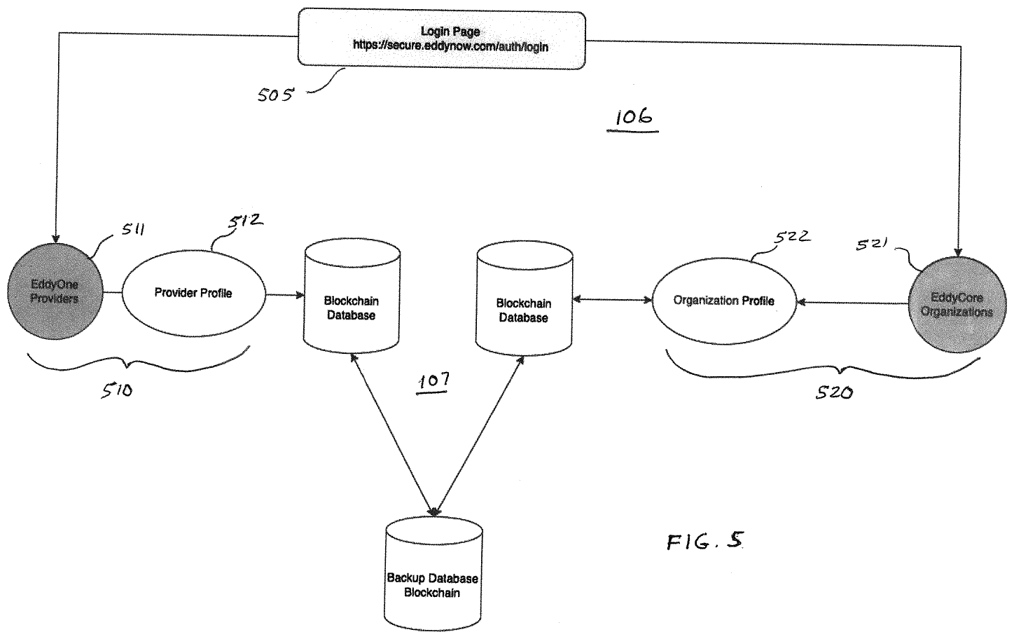

Referring to FIG. 5, the credentialing system 106 can maintain two distributed ledger databases: Providers 510 and Organizations 520. User access is role-based when logging into the credentialing system at its homepage 505 via the Internet (e.g., https://secure.eddynow.com/auth/login). Providers 511 can create a Profile 512 in the credentialing system 106 (“EddyOne”) by entering data and uploading documents required for verifying professional credentials. Organizations 521 can create a Profile 522 in the credentialing system (“EddyCore”) and manage required processes. The credentialing system 106 can utilize the blockchain to mirror data from both previously mentioned databases that initially created by the credentialing system 106.

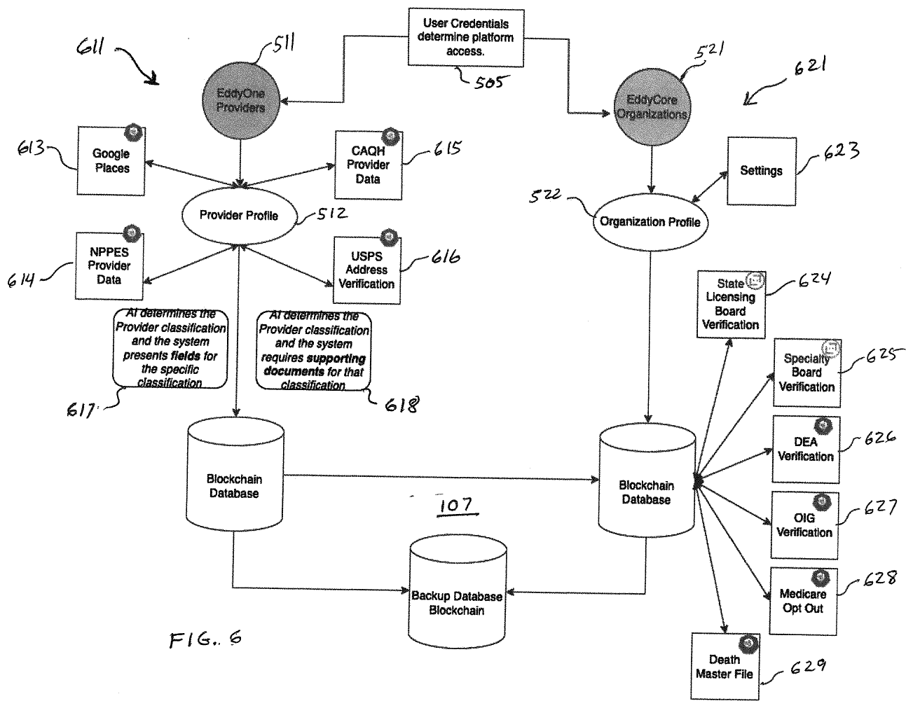

Referring to FIG. 6, during registration, users can be separated into organizations 521 and providers 511. The same URL can be accessed via the credentialing homepage 505 by both entities to log in, and their username/password can signal the system as to which platform they should be directed: either the EddyOne—Provider platform 611 or the EddyCore—Organization platform 621.

Within the EddyOne Provider platform 611, a provider profile can be created via manual data entry in parallel with multiple third party integrations that can populate field within the provider profile 512. Third party integration can come from, for example, Google Places 613, NPPES provider data 614, CAQH provider data 615, USPS address verification 616. A s shown in block 617, artificial Intelligence (AI) 108 within the system 106 can determine the provider's classification and adapt the common form fields according to the provider classification, location, certifications, etc., which can reduce the time required to complete provider profiles. As shown in block 618, required documentation can also requested from the provider according to determinations made by the integrated AI 108, reducing the need to filter through a general request and reducing completion time.

Within EddyCore—Organization platform 621, institutional users can create a profile 522 and apply settings 623 according to its unique requirements. Providers can give permission to Organizations to access EddyOne profiles, and data can be maintained in a blockchain database 107 for that organization. Verifications can be completed by accessing third-party entities, such as: state licensing boards 624, specialty boards 625, DEA 626, OIG 627, Medicare 628, and Death Master Files 629. Verification data and documents can be secluded (secured) from the Provider's profile, per regulatory compliance requirements. Both the Provider database and Organization database can be supported by a backup database via the distributed ledger 107 that mirror both.

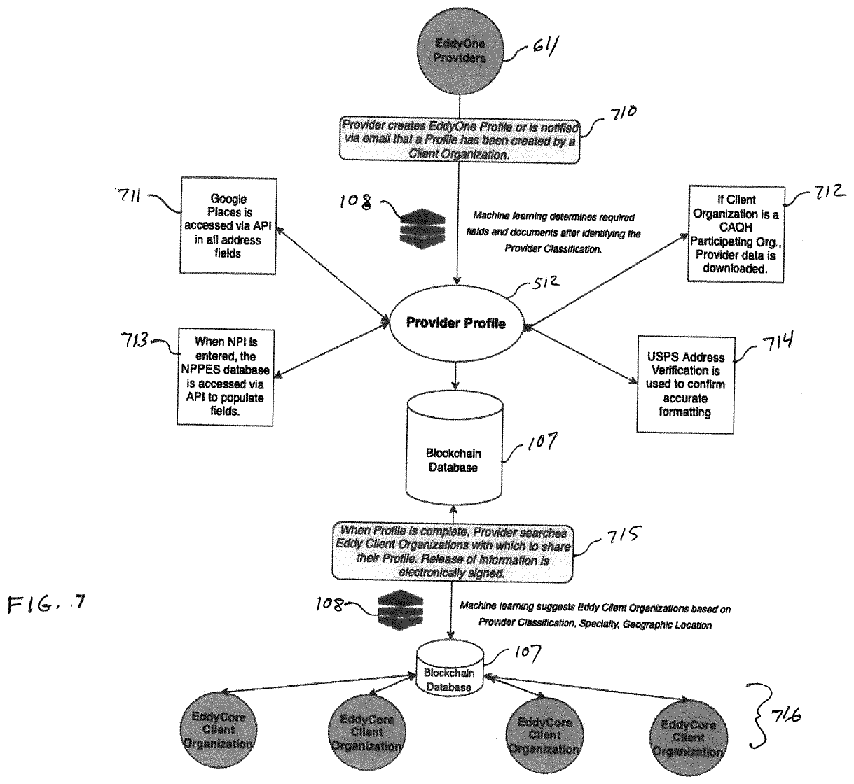

Referring to FIG. 7, AI 108 within the EddyOne—Provider platform 611 of the credentialing system 106 can adapt the common form fields according to the provider classification, location, certifications, etc., reducing the time required to complete profiles. When completing a profile 512, providers can be presented with multiple opportunities to populate fields with third-party data or be notified that the provider can do as shown in block 710. Google Places 711 can be used for addresses, healthcare facilities, schools, etc. If a Provider's facility is a CAQH Participating Organization, then provider data can be imported directly from their CAQH Profile 712. National Provider Identifier 713 can be assigned through NPPES, and that data can be retrieved via API when a provider enters their NPI. USPS 714 information can be referenced for address verification. When a provider enters an NPI, Taxonomy Code or Provider Type, the system can use AI to customize the required fields and required documents based on the provider classification. This allows providers to complete only the fields that are applicable to their use case and reduces the completion time. Provider Profile Data and Documentation can be stored in the blockchain database 107 which can be then accessed by client organizations to which authorization has been granted. The system 106 can allow for the sharing of data with multiple entities simultaneously while secluding verification information for each. As shown in block 715, a provider can search for client organization with which to share data once the profile is complete and released information can be electronically signed. AI can also suggest organizations to the provide based on the providers classification, specialty and/or geographic location. Organizations 716 can access, or be provided, provider data from the blockchain 107. Client organizations 716 can access, or be provided, provider data from the blockchain 107. Provider profiles saved in the blockchain database can also be shared with multiple Organizations simultaneously once the Provider has electronically authorized access to each.

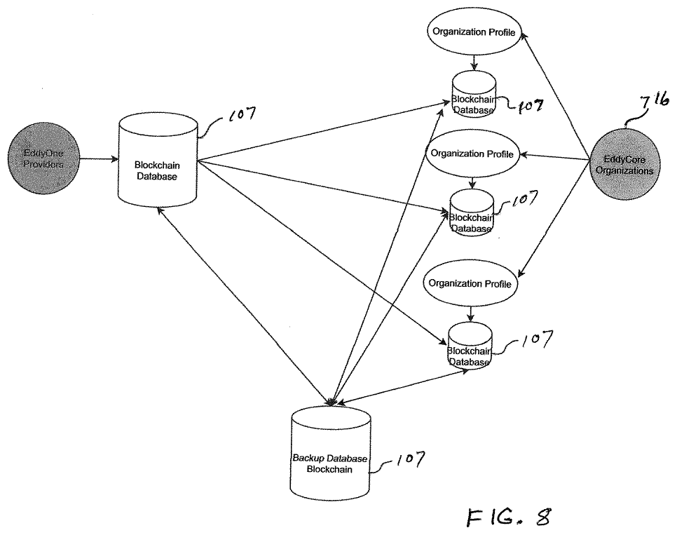

Referring to FIG. 8, organization profiles 810 and Provider databases can be stored in separate distributed ledger 107 environments, and each mirrored in the backup blockchain 107. Organizations 716 can access, or be provided, provider data from the blockchain 107 based on their profiles 810.

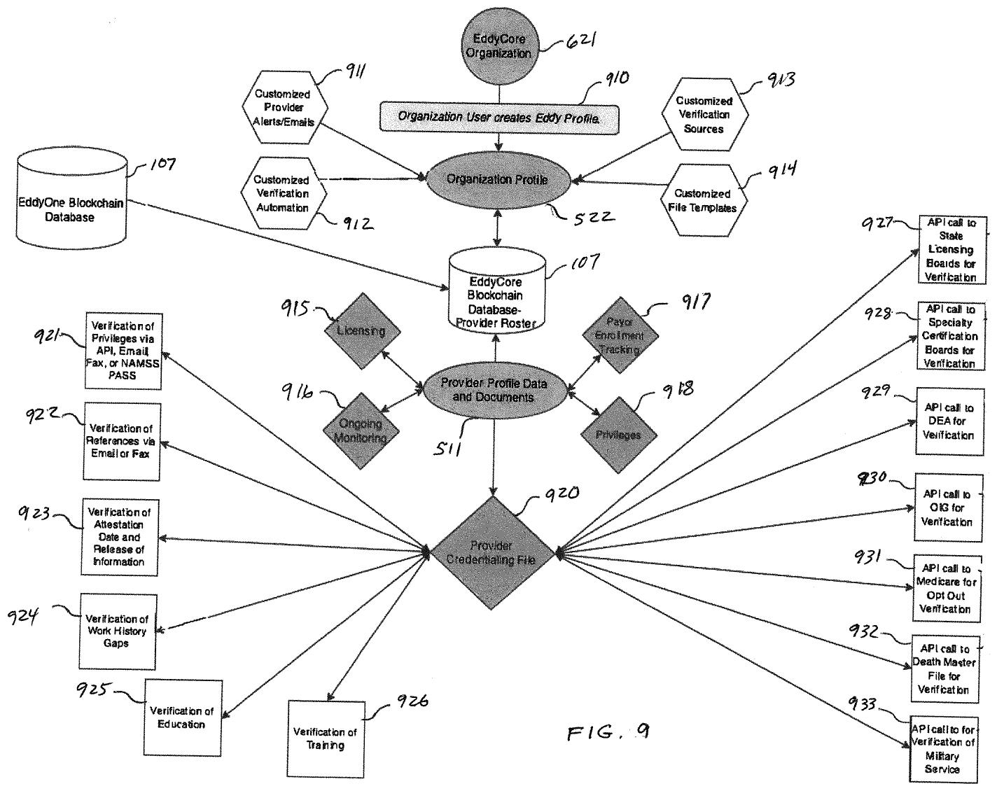

Referring to FIG. 9, a diagram of addition details for aspects of the EddyCore—organization platform 621 that can be integrated in the credentialing system 106 is illustrated. An organization user can create an organization profile 522 as shown in block 910. Organization profiles 522 can allow for multiple customizations based on a facility's bylaws and/or policies and procedures. Customizations can include: organizational documents required for individual and facility credentialing and optional digital signature request, primary source verification data points required for initial and renewal of a provider's appointment, automated verification processes based on system triggers (block 912), automated emails based on system triggers or scheduled ad hoc and the ability to differentiate emails for provider classifications, locations, specialties (block 911), ability to select viewable Provider tabs (credentialing, enrollment, monitoring, expirables), file templates with selected documents and differentiated according to provider classifications, locations, specialties, vendors, and other self-appointed distinctions (block 914), select third-party sources for primary source verifications and confirmation of data points including state licensing boards, specialty boards, DEA, OIG, Medicare Opt Out, Death Master File, NSOPW (Sex Offender Registry), AMA, NPDB, NPPES, ABMS, and more (block 914). A provider profile can be accessed via the EddyCore blockchain database 107 for an organization, which can receive any updated information in real time, should a provider edit their profile. Within a provider's profile, organization users can manage credentialing to include licensing 915, payor enrollment tracking 917, ongoing monitoring 916, and privileges 918.

Provider credentialing files 920 can be completed within a PSV Worklist that is populated according to the organization's settings with the provider's profile data. Items from the worklist can include privileges verified via API, Email, Fax, or NAMSS PASS (block 921). Verification documentation can be saved in a PSV Worklist. References can be verified via Email or Fax (block 922). Verification documentation can be saved in the PSV Worklist. The provider's signed attestation and release of information can be verified by the system and confirmed visually by the user (block 923). Work history gaps can be verified manually by the user (block 924). Verification documentation can be saved in the PSV Worklist. Education level can be verified via the associated institution, FSMB, AMA or NAMSSPASS (block 925). Verification documentation can be saved in the PSV Worklist. Training can be verified via the associated institution, FSMB, AMA or NAMSSPASS (block 926). Verification documentation can be saved in the PSV Worklist. An API call to the reported state licensing board verifies state licenses (block 927). Verification documentation can be saved in the PSV Worklist. An API call to the reported specialty certification board can verify any certifications (block 928). Verification documentation can be saved in the PSV Worklist. An API call to the DEA Diversion Control Unit can verify DEA certification (block 929). Verification documentation can be saved in the PSV Worklist. An API call to the OIG Exclusions Database can verify the provider's OIG status (block 930). An API call to the Provider Opt-Out Affidavits Lookup System can verify the provider's participation in Medicare (block 931). Verification documentation can be saved in the PSV Worklist. An API call to the NTIS Death Master File can confirm that the provider is not listed (block 932). Verification documentation can be saved in the PSV Worklist. An API call to DMDC can verify military service (block 933). Verification documentation can be saved in the PSV Worklist. All verification documents can be filed in an order determined by the organization user in settings. When a user finalizes a credentialing file, the documents can be wrapped up and the file can be saved for future access. This credentialing file is not accessible by the provider per regulatory requirements. Verifications for each facility can be stored separately, as that information is proprietary to the organization that initiated the verification.

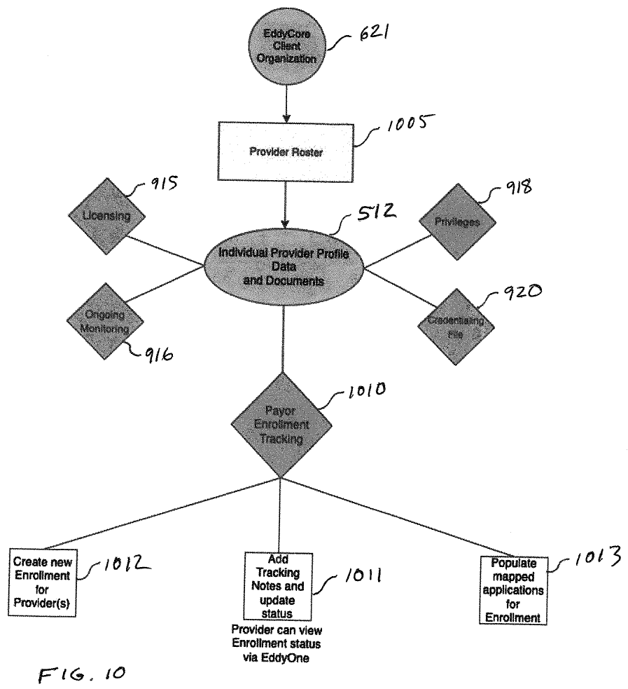

Referring to FIG. 10, a diagram of an EddyCore—Payor Enrollment Tracking aspect of the embodiments is illustrated. Payer enrollment tracking 1010 can occur under the EddyCore —organization platform 621. A new enrollment can be created for providers as shown in block 1012 by accessing the provider roster 1005 and profile data 1006 indicated in Settings. Tracking notes can be added for each interaction: submission, phone call, email, fax, other, as shown in block 1011. The status per payor can be updated and is visible by the provider. Enrollment Application PDFs can be accessed via a forms library and saved in enrollment tracking notes. Online applications can be populated via data mapping between the application and Eddy common form, as shown in block 1013. AI can suggest payors based on provider classification, specialty, location and more. Access to enrollment tracking according to user permissions in Settings.

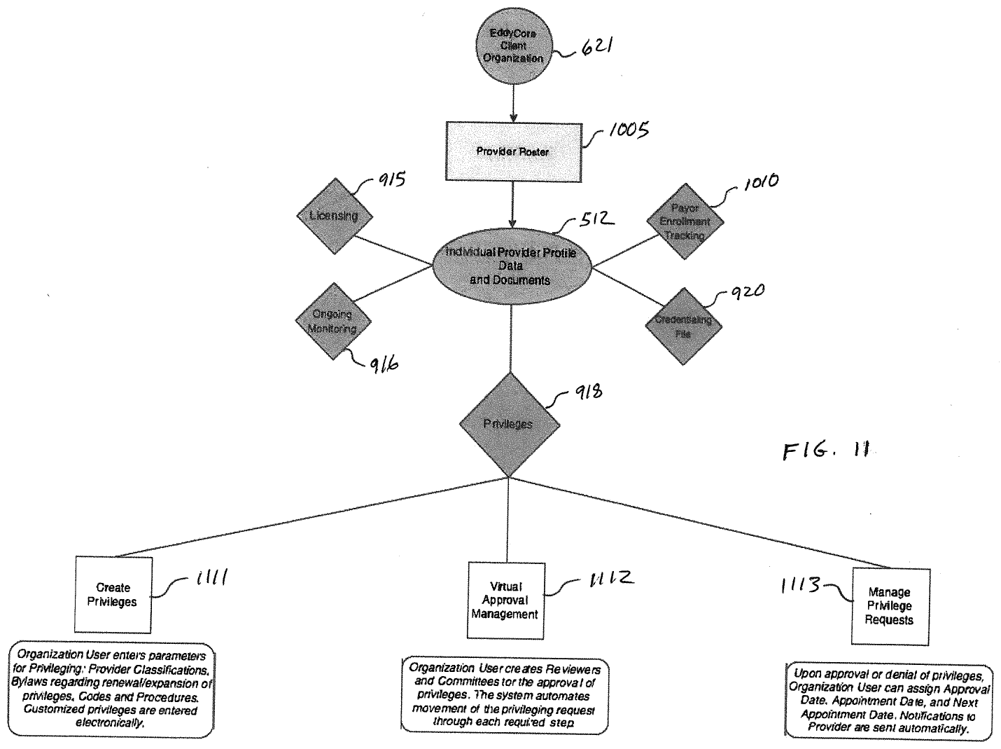

Referring to FIG. 11, a diagram for the privileges 918 aspects is illustrated. As shown in block 1111, an organization user can enter parameters for privileging based on provider classifications and specialties, bylaws, initial/renewal/expansion, ICD-10 and CPT codes. Procedures for Core Privileges can be entered electronically with the requirements for each and the corresponding codes. Referring to block 1112, virtual approval management can be accomplished when an organization user creates reviewers and committees for the approval of requested privileges for providers. The process can be automated by the system and recorded in a digital user log. Referring to block 1113, privilege requests can be managed where reviewers and committees view privilege requests electronically, add notes electronically, and collaborate for an approval, approval with conditions, or no approval. The system can then prompt the user for an approval date, appointment date, and next appointment date. Notifications can be sent to the requesting Provider automatically. Provider privilege information can be saved in an Eddy provider directory to be accessed across the facilities.

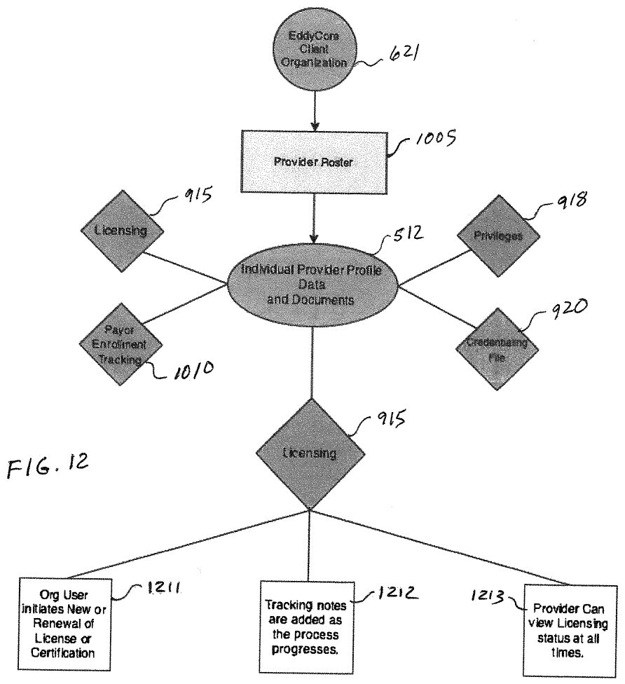

Referring to FIG. 12, a diagram for licensing 915 aspects is illustrated. As shown in block 1211, an organization user can initiate a new or renewal of a provider license or certificate. As shown in block 1212, tracking notes can be added and status updates visible by the provider. As shown in block 1213, a provider can always view licensing status on the platform.

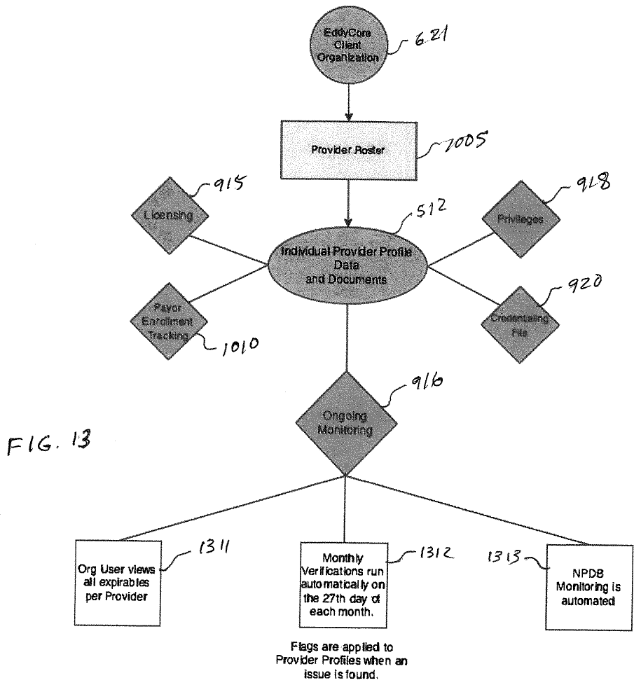

Referring to FIG. 13, a diagram of the ongoing monitoring 916 aspects is illustrated. As shown in block 1311, an organization user can view all expirable data points for each provider. As shown in block 1312, monthly verifications can run automatically on a chosen day, e.g., the 27th day, of each month. Flags can be applied to provider profiles when an issue is determined by the system. As shown in block 1313, NPDB ongoing monitoring can be executed in a tab that can be assigned on the user interface of a client as shown in FIG. 1 that can be selected with viewable results.

Various embodiments provide techniques to store and provide access to information an owner (i.e., medical provider) intends to keep private but in public ledger that can be seen and audited by authorized entities or individuals. There are privacy laws world-wide that require information to be kept private. Various embodiments can ensure compliance with those privacy laws by ensuring the data is stored in correct formats and only accessible in compliant manners. The ability to obfuscate or keep private certain information is imperative for some users. Obfuscation of information can be carried out by applying encryption for an authorized user to be able to view the information.

Systems, methods, and software applications can generate a customized view of a blockchain transaction. A blockchain of block entries requested by a variety of users (e.g., medical service provider, healthcare organization, associated third parties) from user devices can be maintained in a distributed network of nodes. The block entries each can include a plurality of data portions that are each associated with an access level that can be set by a user (e.g., the medical service provider). A request to view one or more data portions of a block entry can be received which includes an access code associated with an assigned access level. The access code in the request can be evaluated with the blockchain of block entries to identify one or more data portions associated with the access level. A customized view of the block entry can be generated which includes the one or more data portions associated with the access level assigned to a reviewer (e.g., healthcare organization) by the data owner (e.g., medical service provider).

A password can be a part of a decentralized application powered by the blockchain that would enable a user to submit, add or attach information going into a blockchain. In some embodiments, this information can be set up in a decentralized manner so information can automatically be inserted and tested and monitored on a decentralized network in real-time so that information is not leaked out or hacked or seen by parties that are not permitted.

Although the embodiments describe a system and methods in support of medical service provider credential and privileges, it should be appreciated that the system and methods can apply to other industries and professions where a provider of services requires credentialing or verifying. For example, oil and gas worker may require equipment licensing and certifications to work for an oil and gas company. A lender for commercial equipment financing entity may require risk screening of a potential borrower. Applications and documents can be provided for credentialing and verifying across numerous fields.

Accordingly, embodiment described herein include system for providing credentialing and privilege processing, management, control, and data exchange for authorized users that include a server accessible from clients over a data network, the server providing centralized credentialing forms to service providers and adapted for receiving supplemental information in association with service provider applications associated with a service provider, an artificial intelligence (AI) module configuring the server to process input and data provided from at least one of a service provider and third party sources on behalf of the service provider, wherein the AI module can populate credentialing forms and an access level to one or more data portion of records and forms associated with the service provider by reviewing parties, and access to a blockchain network. The blockchain network can be adapted to authenticate and grant access to the records and forms associated with the service provider to organizations authorized by the service provider to access and provide records in support of the service provider application for privileges, and thereby access the records after a log-in to the server by the organizations.

The blockchain network can be further configured to blockchain network is configured by the server to: receive a signal encoding data representative of a request to view the one or more data portions of a blockchain entry that are access-controlled; identify the one or more data portions, and an access level, associated with the request; validate access to view the one or more data portions based on the access level; generate a customized view of any of the one or more data portions according to the access level; and cause the customized view to be displayed via a user device in response to the validating the access.

One or more non-transitory computer readable media can be provided having program instructions stored thereon which, when executed by at least one processor, cause a machine to: receive a request to view one or more access-controlled data portions of a blockchain entry representing service provider data in support of credentialing; identify the one or more data portions, and an access level set by a data provider, associated with the request; and generate a customized view of any of the one or more data portions according to the access level. When executed by the at least one processor, the program instructions can further cause the machine to apply at least one redaction to any of the one or more data portions not associated with the access level. When executed by the at least one processor to receive the request, the program instructions further cause the machine to receive data representative of an access code associated with the request. The data representative of the access code includes at least one of: a pin code, a password, a fingerprint, a barcode, a retinal scan, a token, a questionnaire, and a multi-factor security authenticator. When executed by the at least one processor, the program instructions further cause the machine to validate access to view the one or more data portions based on the access level, and wherein when executed by the at least one processor to generate the customized view, the program instructions further cause the machine to generate the customized view in response to the access being validated. When executed by the at least one processor, the program instructions further cause the machine to evaluate the access level to determine the any of the one or more data portions accessible by the request, and wherein when executed by the at least one processor to generate the customized view, the program instructions further cause the machine to generate the customized view in response to the access level being evaluated.

A method in accordance with the embodiments can be provided for providing credentialing and privilege processing, management, control, and exchanges of data for authorized users. As part of the method, a server accessible from clients over a data network can be provided, the server providing centralized credentialing forms to service providers and adapted for receiving supplemental information in association with service provider applications associated with a service provider. An artificial intelligence (AI) module can be provided that configures the server to process input and data provided from at least one of a service provider and third party sources on behalf of the service provider, wherein the AI module can populate credentialing forms and an access level to one or more data portion of records and forms associated with the service provider by reviewing parties. Access to a blockchain network can be provided, wherein the blockchain network can be configured to: authenticate and grant access to the records and forms associated with the service provider to an organization authorized by the service provider to access and provide records in support of the service provider application for privileges, and thereby access after a log-in to the server, to the organization. The blockchain network can be further configured by the server to: receive a signal encoding data representative of a request to view the one or more data portions of a blockchain entry that are access-controlled; identify the one or more data portions, and an access level, associated with the request; validate access to view the one or more data portions based on the access level; generate a customized view of any of the one or more data portions according to the access level; and cause the customized view to be displayed via a user device in response to the validating the access.

Authenticating and granting access to records and forms associated with the service provider can include registering the service provider with a centralized credentialing and privilege/management administration system associated with the server, in response to a user input. Registering of the service provider can further include electronically setting up a personal profile; electronically filling out at least one medical provider application among the service provider applications; uploading credential documents; and identifying references. The credential documents can include at least one of: a college degree or a license. The references can include peer references. The server can further provide monitoring of a status of at least one service provider application among the service provider applications when the service provider has logged into the server and after the registering is complete. Authenticating and granting of access to the records and forms associated with the service provider can include registering the service provider with a centralized credentialing and privilege/management administration system associated with the server, in response to a user input. Registering of the service provider can include electronically setting up a personal profile, electronically filling out at least one service provider application among the service provider applications; uploading credential documents and identifying references. Credential documents can include at least one of: a college degree or a license. References can include peer references. Third parties can include hospitals and third party institutions include credentialing agents. The server can operate to allow the credentialing agents to send and/or receive text messages from the organizations and third party institutions.

A technical effect that may be appreciated from the present discussion is the increased efficiency in identifying entry data that a user is authorized to access and providing a customized view of the data that was recorded in the blockchain transaction. Some of the embodiments described herein also improve security by only allowing access to the user if the user has authorization to access the portion of data from the blockchain entry. In addition, some embodiments can provide an immutable log showing when and who accessed various data. In addition, in some embodiments, automatic review (e.g., by an artificial intelligence or machine learning engine) can occur to detect specific events

1. A system for providing credentialing and privilege processing, management, control, and data exchange for authorized users, comprising:
a server accessible from clients over a data network, the server providing centralized credentialing forms to service providers and adapted for receiving supplemental information in association with service provider applications associated with a service provider;
an artificial intelligence (AI) module configuring the server to process input and data provided from at least one of a service provider and third party sources on behalf of the service provider, wherein the AI module can populate credentialing forms and an access level to one or more data portion of records and forms associated with the service provider by reviewing parties;
access to a blockchain network adapted to:
authenticate and grant access to the records and forms associated with the service provider to organizations authorized by the service provider to access and provide records in support of the service provider application for privileges, and thereby access the records after a log-in to the server by the organizations.

2. The system of claim 1, wherein the blockchain network is configured by the server to:
receive a signal encoding data representative of a request to view the one or more data portions of a blockchain entry that are access-controlled;
identify the one or more data portions, and an access level, associated with the request;
validate access to view the one or more data portions based on the access level;
generate a customized view of any of the one or more data portions according to the access level; and
cause the customized view to be displayed via a user device in response to the validating the access.

3. One or more non-transitory computer readable media having program instructions stored thereon which, when executed by at least one processor, cause a machine to:
receive a request to view one or more access-controlled data portions of a blockchain entry representing service provider data in support of credentialing;
identify the one or more data portions, and an access level set by a data provider, associated with the request; and
generate a customized view of any of the one or more data portions according to the access level.

4. The one or more non-transitory computer readable media of claim 3, wherein when executed by the at least one processor, the program instructions further cause the machine to apply at least one redaction to any of the one or more data portions not associated with the access level.

5. The one or more non-transitory computer readable media of claim 3, wherein when executed by the at least one processor to receive the request, the program instructions further cause the machine to receive data representative of an access code associated with the request.

6. The one or more non-transitory computer readable media of claim 5, wherein the data representative of the access code includes at least one of: a pin code, a password, a fingerprint, a barcode, a retinal scan, a token, a questionnaire, and a multi-factor security authenticator.

7. The one or more non-transitory computer readable media of claim 3, wherein when executed by the at least one processor, the program instructions further cause the machine to validate access to view the one or more data portions based on the access level, and wherein when executed by the at least one processor to generate the customized view, the program instructions further cause the machine to generate the customized view in response to the access being validated.

8. The one or more non-transitory computer readable media of claim 3, wherein when executed by the at least one processor, the program instructions further cause the machine to evaluate the access level to determine the any of the one or more data portions accessible by the request, and wherein when executed by the at least one processor to generate the customized view, the program instructions further cause the machine to generate the customized view in response to the access level being evaluated.

9. A method for providing credentialing and privilege processing, management, control, and exchanges of data for authorized users, comprising:
providing a server accessible from clients over a data network, the server providing centralized credentialing forms to service providers and adapted for receiving supplemental information in association with service provider applications associated with a service provider;
providing an artificial intelligence (AI) module configuring the server to process input and data provided from at least one of a service provider and third party sources on behalf of the service provider, wherein the AI module can populate credentialing forms and an access level to one or more data portion of records and forms associated with the service provider by reviewing parties;
providing access to a blockchain network configured to:
authenticate and grant access to the records and forms associated with the service provider to an organization authorized by the service provider to access and provide records in support of the service provider application for privileges, and thereby access after a log-in to the server, to the organization.

10. The method of claim 9, wherein the blockchain network is further configured by the server to:
receive a signal encoding data representative of a request to view the one or more data portions of a blockchain entry that are access-controlled;
identify the one or more data portions, and an access level, associated with the request;
validate access to view the one or more data portions based on the access level;
generate a customized view of any of the one or more data portions according to the access level; and
cause the customized view to be displayed via a user device in response to the validating the access.

11. The method of claim 9, wherein authenticating and granting access to records and forms associated with the service provider, further comprises registering the service provider with a centralized credentialing and privilege/management administration system associated with the server, in response to a user input.

12. The method of claim 11, wherein the registering of the service provider further comprises:
electronically setting up a personal profile;
electronically filling out at least one medical provider application among the service provider applications;
uploading credential documents; and
identifying references.

13. The method of claim 12, wherein the credential documents include at least one of: a college degree or a license.

14. The method of claim 12, wherein the references include peer references.

15. The method of claim 9, wherein the server further provides monitoring of a status of at least one service provider application among the service provider applications when the service provider has logged into the server and after the registering is complete.

16. The method of claim 9, wherein:
the authenticating and granting of access to the records and forms associated with the service provider, further comprises: registering the service provider with a centralized credentialing and privilege/management administration system associated with the server, in response to a user input;
the registering of the service provider further comprises:
electronically setting up a personal profile;
electronically filling out at least one service provider application among the service provider applications;
uploading credential documents; and
identifying references.

17. The system of claim 16, wherein the credential documents include at least one of: a college degree or a license.

18. The system of claim 16, wherein the references include peer references.

19. The system of claim 10, wherein third parties comprising the hospitals and third party institutions include credentialing agents.

20. The system of claim 19, wherein the server is operable to allow the credentialing agents to send and/or receive text messages from the organizations and third party institutions.
